(19) United States
(12) Patent Application Publication
(10) Pub. No.: US 2016/0098211 A1
(43) Pub. Date: Apr. 7, 2016

(54) IMPLEMENTING ENHANCED PHASE CHANGE MEMORY (PCM) READ LATENCY THROUGH CODING

(71) Applicant: HGST Netherlands B.V., Amsterdam (NL)

(72) Inventors: Zvonimir Z. Bandic, San Jose, CA (US); Cyril Guyot, San Jose, CA (US); Eun Jee Lee, Princeton, NJ (US); Robert Eugeniu Mateescu, San Jose, CA (US); Dejan Vucinic, San Jose, CA (US)

(21) Appl. No.: 14/505,777

(22) Filed: Oct. 3, 2014

(51) Int. Cl. G06F 3/06

(52) U.S. Cl. CPC G06F 3/0611; G06F 3/064; G06F 3/0679

(57) ABSTRACT

A method, apparatus, and storage device are provided for implementing enhanced performance with enhanced phase-change-memory (PCM) read latency through coding. A coding algorithm is used to write data to the PCM including a redundancy chip enabling recovery of inaccessible partition data by reading other partitions. A read operation is served by reading parity lines and computing data for the read operation from a blocked written-to partition.

### FIELD OF THE INVENTION

The present invention relates generally to the data storage field, and more particularly, relates to a method, apparatus, and storage device for implementing enhanced performance with enhanced phase-change-memory (PCM) read latency through coding.

### DESCRIPTION OF THE RELATED ART

Phase-change-memory (PCM) is a promising medium for next generation non-volatile solid-state storage. One of the idiosyncrasies of PCM is the much longer time required to write a bit than to read it; write operations are about fifty times slower than reads.

While multiple partition architecture allows dual operations, when writing to a partition, a read operation can access only other partitions than the written-to partition. During a write operation the written-to partition is blocked off from read access. This means that a read request from a written-to partition has to wait for the write to complete, which is potentially 50 times longer than usual read latency. Otherwise, the write operation must be aborted for the read to proceed in a timely manner and then the write operation is attempted again later.

A need exists to provide an effective and efficient mechanism for implementing enhanced performance for solid state drives (SSDs) with enhanced phase-change-memory (PCM) read latency through coding.

In the following description and claims, the term phase-change-memory (PCM) should be broadly understood to include memory devices having a large asymmetry between to read and write latencies, with reads being faster than writes.

### SUMMARY OF THE INVENTION

Aspects of the present embodiments are to provide a method, apparatus, and storage device for implementing enhanced performance with enhanced phase-change-memory (PCM) read latency through coding. Other important aspects are to provide such method, apparatus, and storage device substantially without negative effect and that overcome some of the disadvantages of prior art arrangements.

In brief, a method, apparatus, and storage device are provided for implementing enhanced performance with enhanced phase-change-memory (PCM) read latency through coding. A coding algorithm is used to write data to the PCM including a redundancy chip enabling recovery of inaccessible partition data by reading other partitions. A read operation is served by reading parity lines and computing data for the read operation from a blocked written-to partition.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a block diagram representation illustrating a system for implementing enhanced performance with enhanced phase-change-memory (PCM) read latency through coding, for example, for solid state drives (SSDs) in accordance with preferred embodiments;

FIGS. 2A and 2B are diagrams illustrating an example arrangement of the PCM chip of the system of FIG. 1 for implementing enhanced performance with enhanced phase-change-memory (PCM) read latency through coding, for example, for solid state drives (SSDs) in accordance with preferred embodiments;

FIG. 3 illustrates a typical prior art data write and data read completion time for multiple block sizes for phase-change-memory (PCM) devices;

FIG. 4 illustrates example data write and parity line with example phase-change-memory including a redundancy chip in accordance with preferred embodiments;

FIGS. 5A and 5B respectively illustrate example prior art data write and example data write with example phase-change-memory including a redundancy chip in accordance with preferred embodiments;

FIG. 6 illustrates example arrangement of PCM chips of the system of FIG. 1 for implementing enhanced performance with enhanced phase-change-memory (PCM) read latency through coding, for example, for solid state drives (SSDs) in accordance with preferred embodiments;

FIG. 7 illustrates an example parity line construction of PCM chips of the system of FIG. 1 for implementing enhanced performance with enhanced phase-change-memory (PCM) read latency through coding, for example, for solid state drives (SSDs) in accordance with preferred embodiments;

FIG. 8 illustrates an example parity line construction of PCM chips of the system of FIG. 1 for implementing enhanced performance with enhanced phase-change-memory (PCM) read latency through coding, for example, for solid state drives (SSDs) in accordance with preferred embodiments;

FIGS. 9A an 9B illustrates another example parity line construction of PCM chips of the system of FIG. 1 for implementing enhanced performance with enhanced phase-change-memory (PCM) read latency through coding, for example, for solid state drives (SSDs) in accordance with preferred embodiments;

FIG. 10 illustrates an example variant parity line construction of PCM chips of the system of FIG. 1 for implementing enhanced performance with enhanced phase-change-memory (PCM) read latency through coding, for example, for solid state drives (SSDs) in accordance with preferred embodiments;

FIG. 11 illustrates example read time comparison without coding and with coding with example phase-change-memory including a redundancy chip in accordance with preferred embodiments; and

FIG. 12 is a block diagram illustrating a computer program product in accordance with preferred embodiments.

### DETAILED DESCRIPTION OF THE PREFERRED EMBODIMENTS

In the following detailed description of embodiments of the invention, reference is made to the accompanying drawings, which illustrate example embodiments by which the invention may be practiced. It is to be understood that other embodiments may be utilized and structural changes may be made without departing from the scope of the invention.

In accordance with features of preferred embodiments, a method, apparatus, and storage device are provided for implementing enhanced performance with enhanced phase-change-memory (PCM) read latency through coding.

In accordance with features of preferred embodiments, the written data is using a coding algorithm that enables recovering an inaccessible partition by reading other partitions.

In accordance with features of preferred embodiments, the coding algorithm provides parity lines where any two lines share at most one partition across all chips of the phase-change-memory (PCM) and a number of chips is maximized. The coding scheme of preferred embodiments reduces read and writes latency on PCM multiple partitioned chips. The data is made available through coding, which reduces the probability of the worst read cases and enables recovery of the inaccessible partition by reading other partitions and simple encoding and decoding calculation, such as exclusive OR (XOR) calculation.

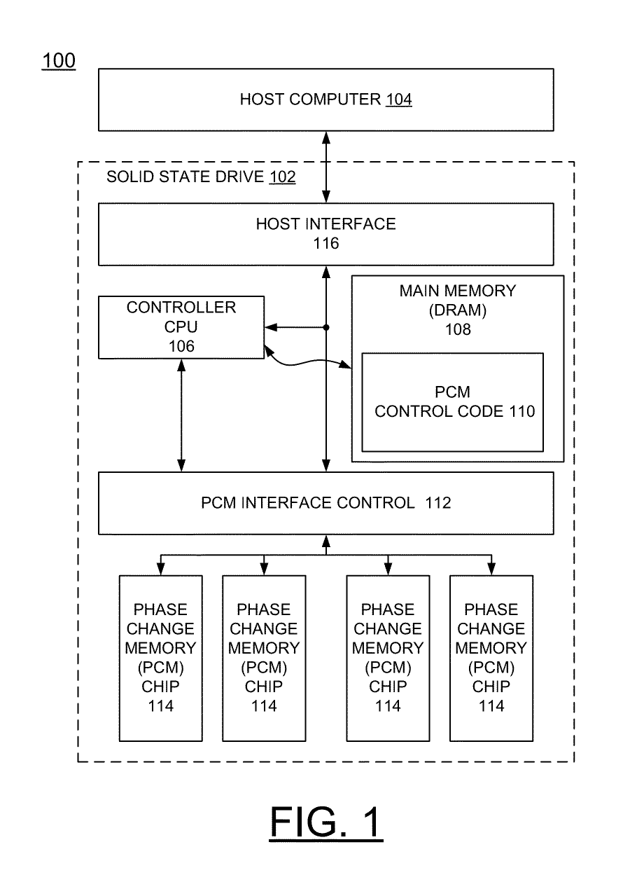

Having reference now to the drawings, in FIG. 1, there is shown an example system for implementing enhanced performance with enhanced phase-change-memory (PCM) read latency through coding, for example, for solid state drives (SSDs) generally designated by the reference character 100 in accordance with preferred embodiments. System 100 includes a solid state drive 102 and a host computer 104. SSD 102 includes a controller 106 coupled to a main memory or dynamic random access memory (DRAM) 108, a phase-change-memory (PCM) control code 110 and a phase-change-memory (PCM) interface control 112.

SSD 102 includes a plurality of phase-change-memory (PCM) devices or chips 114 coupled to the PCM interface control 112, which are coupled to the controller 106. SSD 102 includes a host interface 116 coupled between the host computer 104, and the controller 106 and the phase-change-memory (PCM) interface control 112.

Although the example embodiment of system 100 is described in the context of the solid state drive 102, it should be understood that principles of the preferred embodiments advantageously are applied to other types of data storage devices including phase-change-memory (PCM).

System 100 is shown in simplified form sufficient for understanding preferred embodiments. For example, the controller 106 can be fabricated on one or multiple integrated circuit dies, and is suitably programmed to implement methods in accordance with preferred embodiments.

SSD 102 implements enhanced phase-change-memory (PCM) read latency through coding in accordance with preferred embodiments. The controller 106 of SSD 102 includes firmware, such as PCM control code 110, and is given direct access PCM interface control block 112. The firmware of controller 106 of SSD 102 is given information with respect to PCM interface control block 112, for example, from PCM control code 110.

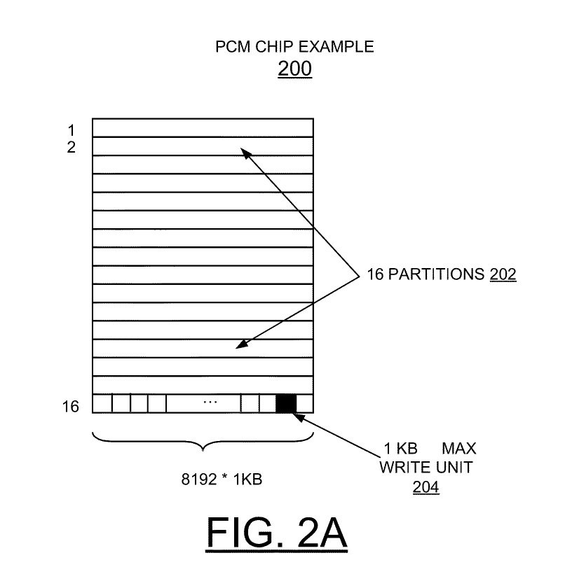

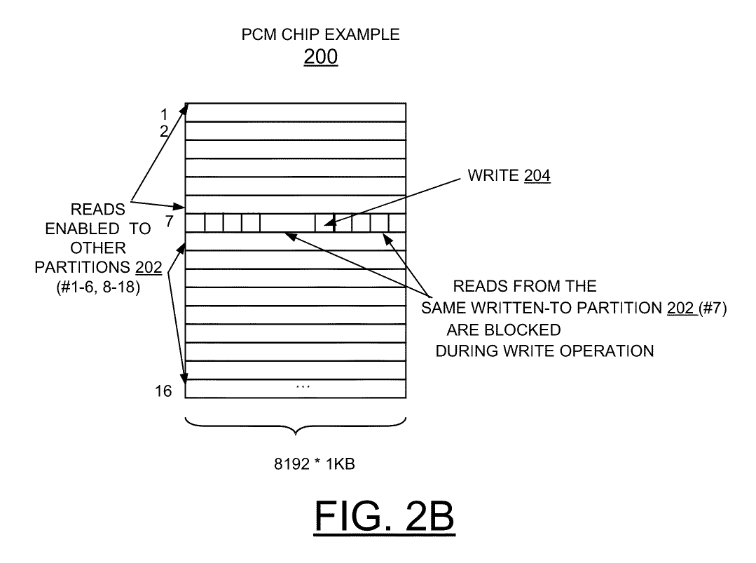

Referring now to FIGS. 2A and 2B, there is shown an example PCM chip generally designated by the reference character 200 of the system 100 for implementing enhanced performance with enhanced phase-change-memory (PCM) read latency through coding in accordance with preferred embodiments. PCM chip 200 includes a plurality of partitions 202, #1-16, as shown, and a predefined maximum write unit 204, such as 1 KB. The chip capacity is, for example, 1 Gb or 128 MB, with a partition capacity of 8 MB.

As shown in FIG. 2B, a write 204 to partition 202, #7 blocks reads from the same written-to partition 202, #7 during the write operation. Reads are enabled to other partitions 202, #1-6, 8-16 during the write operation. Reading to a PCM chip is a simple resistance measurement, for example, as fast as reading to dynamic random access memory (DRAM), such as 10× nsec (nano-seconds). Writing is at least 50 times slower than a read operation. A read operation to the written-to partition 202, #7 needs to wait until the writing is finished; or an interrupt optionally is generated.

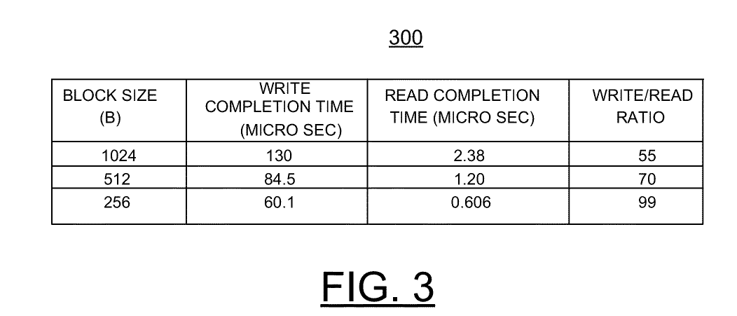

Referring now to FIG. 3, there are shown typical example prior art data write and data read completion time generally designated by the reference character 300 for multiple block sizes for phase-change-memory (PCM) devices. As shown, both the read and write completion time decrease with smaller write block size, while the write to read ratio increases. As shown, with a 1 KB block size, an example read completion time of 2.38 micro-seconds is shown with the write to read ratio of 55.

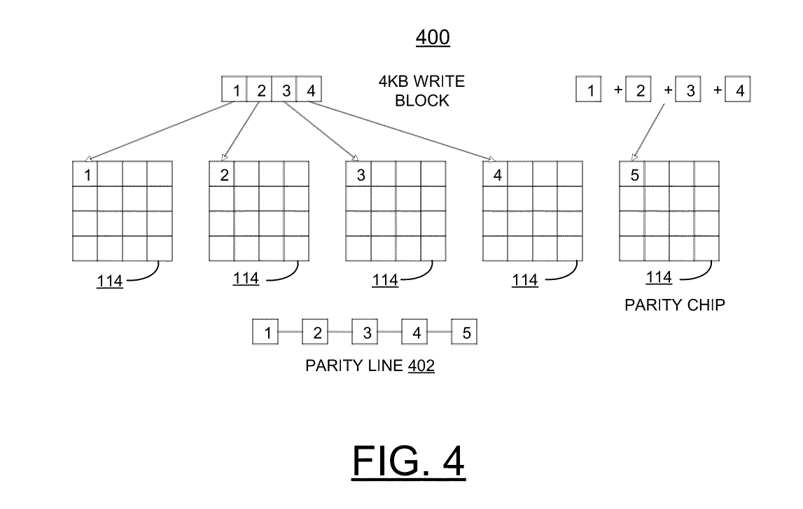

Referring now to FIG. 4, there are shown example data write and parity line with example phase-change-memory including a redundancy chip generally designated by the reference character 400 in accordance with preferred embodiments. As shown, with a 4 KB write block, and a 1 KB maximum write unit, (other combinations are possible), four chips 114 with blocks 1, 2, 3, 4 being written in parallel with and additional chip 114, parity chip is used to maintain coded data, such as, exclusive OR (XOR) coded data. A parity line 402 is shown including the 4 KB write block, or blocks 1, 2, 3, 4 written in four chips 114, and parity block 5 in the fifth parity chip 114.

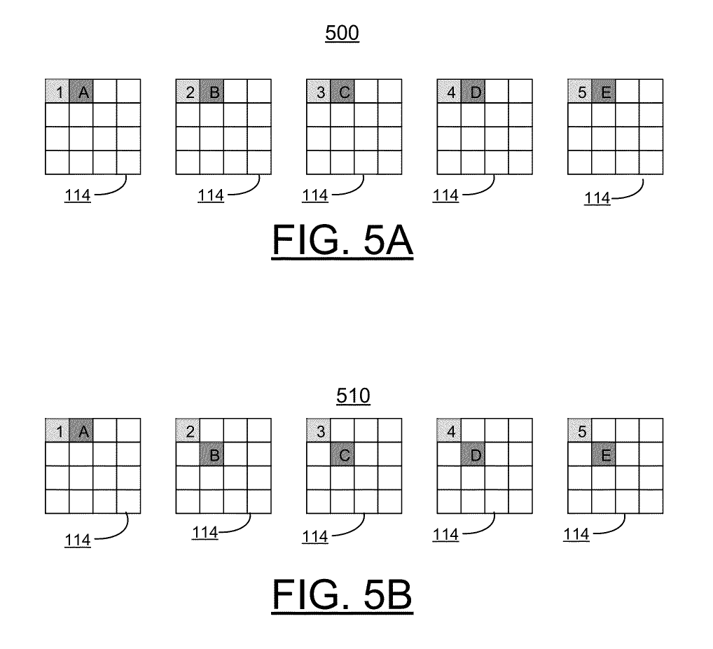

Referring now to FIGS. 5A and 5B, there are respectively shown example prior art data write generally designated by the reference character 500 and example data write generally designated by the reference character 510 with example phase-change-memory 114 including a redundancy chip in accordance with preferred embodiments. In FIG. 5A, when blocks 1, 2, 3, 4 are written, A, B, C, D, cannot be read because the top partition is blocked in all five chips, 114. In FIG. 5B, when blocks 1, 2, 3, 4 are written in chips 1-4, 114, B, C, D, E can be read from chips 2-5, 114, recovering data A from the parity data E stored in chip 5, 114 in accordance with preferred embodiments.

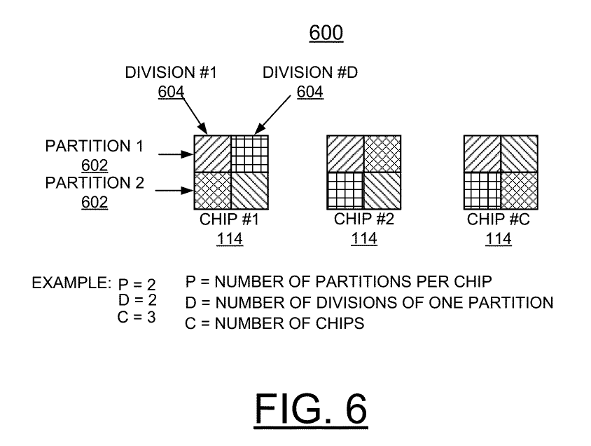

Referring now to FIG. 6, an example arrangement generally designated by the reference character 600 is illustrated of PCM chips 114 of the system 100 for implementing enhanced performance with enhanced phase-change-memory (PCM) read latency through coding, for example, for solid state drives (SSDs) in accordance with preferred embodiments. In the illustrated example PCM chip arrangement 600, each of the chips #1-C, 114 include partitions 602, #1-P with first and second divisions, #1-D, 604.

In accordance with features of preferred embodiments, the written data is using a coding algorithm that enables recovering an inaccessible partition by reading other partitions, and the coding algorithm provides parity lines where any two lines share at most one partition across all phase-change-memory (PCM) chips and a number of chips is maximized.

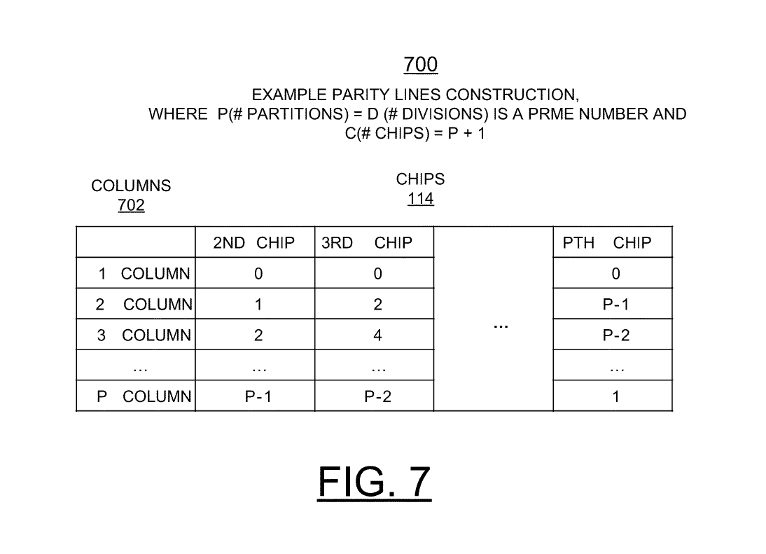

Referring now to FIG. 7, there is shown an example parity line construction generally designated by the reference character 700 of PCM chips 114 of the system 100 for implementing enhanced performance with enhanced phase-change-memory (PCM) read latency through coding, for example, for solid state drives (SSDs) in accordance with preferred embodiments. Construction 700 provides an optimal construction when P (# partitions) is a prime number. As shown, for example, P (# partitions)=D (#Divisions) is a prime number. C (# chips)=P+1 is achievable through column shifts, as shown with columns 702, #1-P, and chips 114, 1-P+1. The (P+1)th matrix (chip 114) is the transpose of the first chip 114. Proof is based on number theory congruence as follows:

{a*b(mod p)|bε{1,2, . . . ,p−1}}={1,2, . . . ,p−1}, where a<p and p is prime number.

a*b(mod p)≡a′*b(mod p)iff a≡a′(mod p), where gcd(b,p)=1.

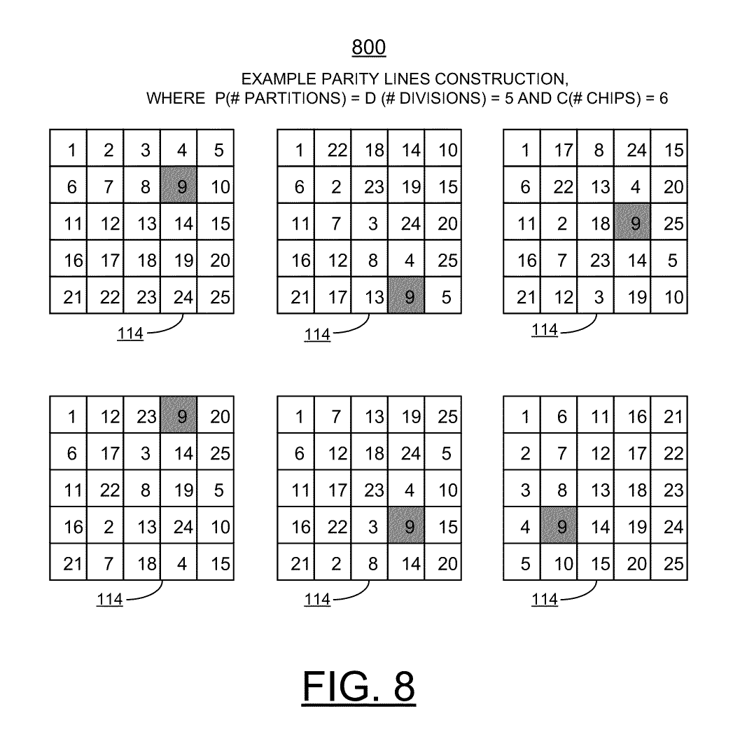

Referring now to FIG. 8, there is shown an example parity line construction generally designated by the reference character 800 of PCM chips 114 of the system 100 for implementing enhanced performance with enhanced phase-change-memory (PCM) read latency through coding, for example, for solid state drives (SSDs) in accordance with preferred embodiments. In the illustrated example parity line construction 800, where P (# partitions)=D (#Divisions)=5, and C (# chips)=6, any number, for example, 9 shown with shading, appears in the same row with any other number exactly once.

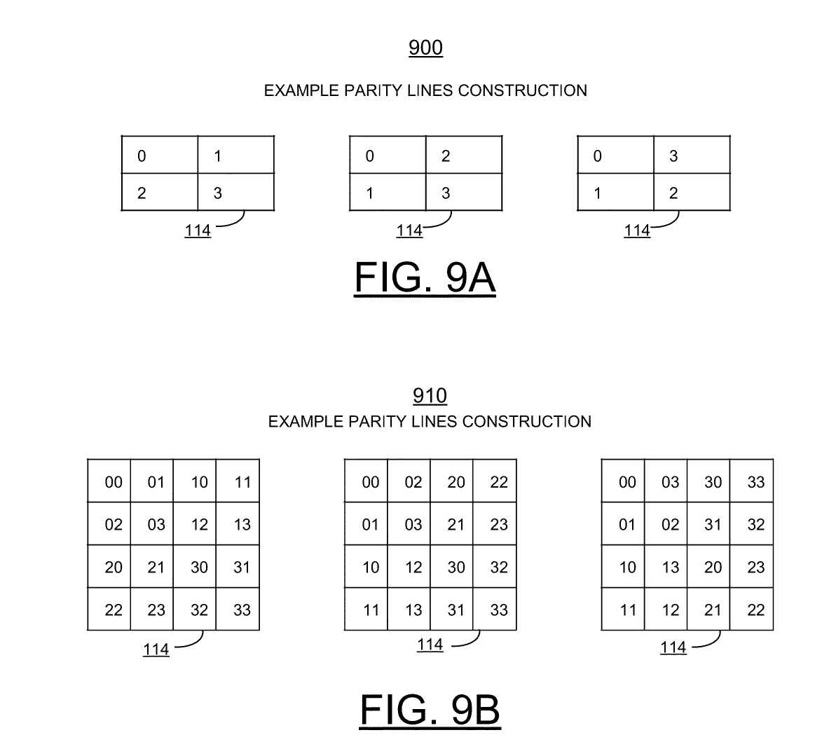

Referring now to FIGS. 9A an 9B, which together illustrate another example parity line construction respectively generally designated by the reference character 900, 910 of PCM chips 114 of the system 100 for implementing enhanced performance with enhanced phase-change-memory (PCM) read latency through coding, for example, for solid state drives (SSDs) in accordance with preferred embodiments. Scaling up the parity line construction, construction of solution (P=(P1)²ⁿ, C=C1) by induction, where a parity line construction 900 for (P1, C1) is known. Represent the parity line construction 910 for (P1, C1) in (P1)^{2-decimal} where parity line construction 910 for (P=(P1)²ⁿ, C=C1) is represented in two digits of (P1)^{2-decimal} numbers. Divide each division of the solution for (P1, C1) into P1 rows and P1 columns and copy the solution to the higher digit, for the lower digit; copy the P1 by P1 solution to four new P1 by P1 divisions. For example, applying the similar scheme, solution (P=(P2*P1)²ⁿ, C=C1) can be constructed where P1<P2 and both solutions for (P1, C1) and (P2, C2) are known.

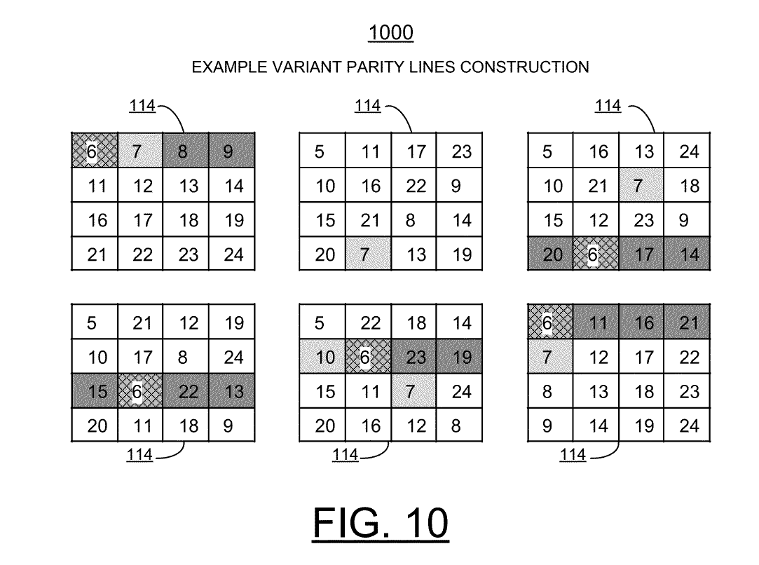

Referring now to FIG. 10, an example variant parity line construction is shown generally designated by the reference character 1000 of PCM chips 114 of the system 100 for implementing enhanced performance with enhanced phase-change-memory (PCM) read latency through coding, for example, for solid state drives (SSDs) in accordance with preferred embodiments. The variant parity line construction 1000 can be implemented for any number of Partitions. Using variant parity line construction for prime number (P, C=P+1), variant parity line construction can be constructed for (P−1, C=P+1) with erasing the row containing the division ‘0’ from each chip, and erasing the left most column from the first chip, and erase the corresponding divisions from the other chips 114. With the variant parity line construction 1000, capacity is reduced by (P−2)/(P−1), and write throughput reduced by P/(P+1), for example, 6 and 7 shown with different shading, 6 is erased from the second chip 114, and 7 is erased from the fourth chip 114.

In accordance with features of preferred embodiments, the written data is using a coding algorithm that enables a parity line construction for any P (prime, or even powers), where prime P, guarantees the maximum C (number of chips). This results in reducing collision probability; that is, reading from the partition being written, by 1/P. With the variant parity line construction, the written data is using a coding algorithm that enables a parity line construction for any P′<P, using the solution for prime P, guarantees the maximum C (number of chips), where C can not be changed, C is always P+1.

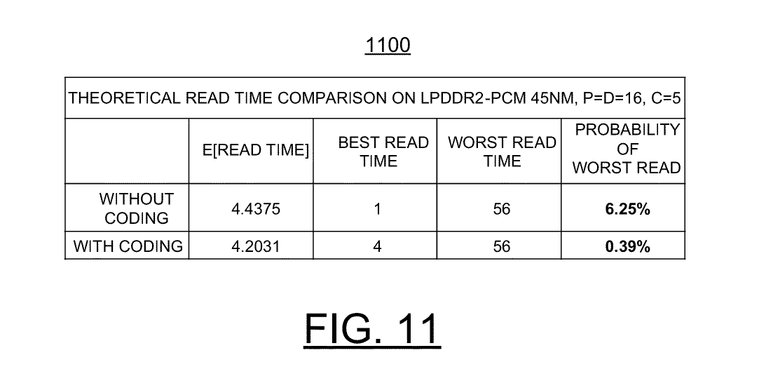

Referring now to FIG. 11 there is shown an example read time comparison generally designated by the reference character 1100 without coding and with coding with example phase-change-memory including a redundancy chip in accordance with preferred embodiments. As shown, the theoretical read time without coding and with coding is 4.4375 and 4.2031 with 1 unit=2.56 microseconds, the probability of a worst read is 6.25% without coding and is significantly improved, 0.39% with coding of the preferred embodiments.

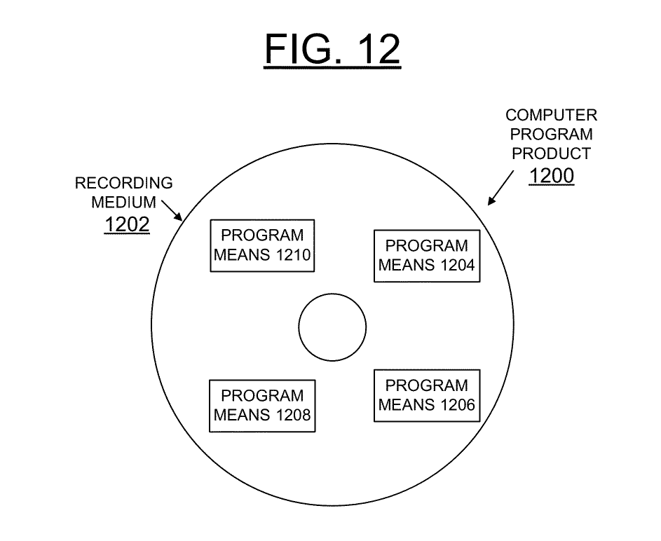

Referring now to FIG. 12, an article of manufacture or a computer program product 1200 of the preferred embodiments is illustrated. The computer program product 1200 includes a computer readable recording medium 1202, such as, a floppy disk, a high capacity read only memory in the form of an optically read compact disk or CD-ROM, a tape, or another similar computer program product. Computer readable recording medium 1202 stores program means or control code 1204, 1206, 1208, 1210 on the medium 1202 for carrying out the methods for implementing enhanced performance for data read to phase-change-memory (PCM) in accordance with preferred embodiments in the system 100 of FIG. 1.

A sequence of program instructions or a logical assembly of one or more interrelated modules defined by the recorded program means or control code 1204, 1206, 1208, 1210, direct SSD controller 106 of the system 100 for implementing enhanced performance with enhance PCM data read latency of preferred embodiments.

While the present invention has been described with reference to the details of the embodiments of the invention shown in the drawing, these details are not intended to limit the scope of the invention as claimed in the appended claims.

What is claimed is:

1. A method for implementing enhanced performance with enhanced phase-change-memory (PCM) read latency to phase-change-memory (PCM) comprising:
providing the PCM including a redundancy chip;
using a coding algorithm to write data to the PCM including the redundancy chip enabling recovering inaccessible partition data by reading other partitions; and
serving a read operation from an otherwise blocked written-to partition by reading parity lines from other partitions and computing data for the read operation.

2. The method for implementing enhanced performance with enhanced phase-change-memory (PCM) read latency to phase-change-memory (PCM) as recited in claim 1 wherein using the coding algorithm to write data to the PCM including the redundancy chip includes providing the coding algorithm to write data with any two parity lines sharing at most one partition across each of a plurality of chips of the phase-change-memory (PCM).

3. The method for implementing enhanced performance with enhanced phase-change-memory (PCM) read latency to phase-change-memory (PCM) as recited in claim 1 wherein using the coding algorithm to write data to the PCM including the redundancy chip includes providing the coding algorithm for enabling an exclusive OR (XOR) encoding and decoding calculation for recovering inaccessible partition data.

4. The method for implementing enhanced performance with enhanced phase-change-memory (PCM) read latency to phase-change-memory (PCM) as recited in claim 1 includes providing the coding algorithm to maintain coded exclusive OR (XOR) data.

5. The method for implementing enhanced performance with enhanced phase-change-memory (PCM) read latency to phase-change-memory (PCM) as recited in claim 1 wherein using the coding algorithm to write data to the PCM includes the redundancy chip maintaining coded exclusive OR (XOR) data.

6. The method for implementing enhanced performance with enhanced phase-change-memory (PCM) read latency to phase-change-memory (PCM) as recited in claim 1 wherein using the coding algorithm to write data reduces a collision probability of read and write operations.

7. The method for implementing enhanced performance with enhanced phase-change-memory (PCM) read latency to phase-change-memory (PCM) as recited in claim 1 wherein using the coding algorithm to write data reduces read and write latency on PCM multiple partitioned chips.

8. An apparatus for implementing enhanced performance with enhanced phase-change-memory (PCM) read latency to phase-change-memory (PCM) comprising:
a controller;
said controller using a coding algorithm to write data to the PCM including a redundancy chip enabling recovering inaccessible partition data by reading other partitions; and
said controller serving a read operation from an otherwise blocked written-to partition by reading parity lines from other partitions and computing data for the read operation.

9. The apparatus for implementing enhanced performance with enhanced phase-change-memory (PCM) read latency to phase-change-memory (PCM) as recited in claim 8 includes control code stored on a non-transitory computer readable medium, and wherein said controller uses said control code for implementing enhanced phase-change-memory (PCM) read latency to phase-change-memory (PCM).

10. The apparatus for implementing enhanced performance with enhanced phase-change-memory (PCM) read latency to phase-change-memory (PCM) as recited in claim 8 wherein said controller using the coding algorithm for write data provides any two parity lines sharing at most one partition across a plurality of chips of the phase-change-memory (PCM).

11. The apparatus for implementing enhanced performance with enhanced phase-change-memory (PCM) read latency to phase-change-memory (PCM) as recited in claim 8 wherein said controller using the coding algorithm to write data to the PCM including the redundancy chip includes said controller providing the coding algorithm for enabling an exclusive OR (XOR) encoding and decoding calculation for recovering inaccessible partition data.

12. The apparatus for implementing enhanced performance with enhanced phase-change-memory (PCM) read latency to phase-change-memory (PCM) as recited in claim 8 includes said controller providing the coding algorithm to maintain coded exclusive OR (XOR) data.

13. The apparatus for implementing enhanced performance with enhanced phase-change-memory (PCM) read latency to phase-change-memory (PCM) as recited in claim 8 wherein said controller using the coding algorithm to write data reduces a collision probability of read and write operations.

14. The apparatus for implementing enhanced performance with enhanced phase-change-memory (PCM) read latency to phase-change-memory (PCM) as recited in claim 8 wherein said controller using the coding algorithm to write data reduces read and write latency on PCM multiple partitioned chips.

15. A data storage device comprising:
a phase-change-memory (PCM) including a redundancy chip;
a controller for implementing enhanced performance with enhanced phase-change-memory (PCM) read latency to the phase-change-memory (PCM);
said controller using a coding algorithm to write data to the PCM including the redundancy chip enabling recovering inaccessible partition data by reading other partitions; and
said controller serving a read operation from an otherwise blocked written-to partition by reading parity lines from other partitions and computing data for the read operation.

16. The data storage device as recited in claim 15, includes control code stored on a non-transitory computer readable medium, and wherein said controller uses said control code for implementing enhanced performance with enhanced phase-change-memory (PCM) read latency to phase-change-memory (PCM).

17. The data storage device as recited in claim 15, wherein said controller using the coding algorithm for write data provides any two parity lines sharing at most one partition across a plurality of chips of the phase-change-memory (PCM).

18. The data storage device as recited in claim 15, wherein said controller using the coding algorithm to write data to the PCM including the redundancy chip includes said controller providing the coding algorithm for enabling an exclusive OR (XOR) encoding and decoding calculation for recovering inaccessible partition data.

19. The data storage device as recited in claim 15, wherein said controller using the coding algorithm to write data reduces a collision probability of read and write operations on PCM multiple partitioned chips.

20. The data storage device as recited in claim 15, wherein said controller using the coding algorithm to write data reduces read and write latency on PCM multiple partitioned chips.
